(19) United States
(12) Patent Application Publication
(10) Pub. No.: US 2015/0254660 A1
(43) Pub. Date: Sep. 10, 2015

(54) Anonymous Electronic Payment System

(71) Applicant: Bank of America Corporation, Charlotte, NC (US)

(72) Inventors: Thayer S. Allison, JR., Charlotte, NC (US); Aaron H. Lai, Alemda, CA (US); Debashis Ghosh, Charlotte, NC (US); David Joa, Pacifica, CA (US)

(21) Appl. No.: 14/716,458

(22) Filed: May 19, 2015

Related U.S. Application Data
(63) Continuation of application No. 12/778,274, filed on May 12, 2010.

(51) Int. Cl. G06Q 20/40

(52) U.S. Cl. CPC G06Q 20/40

(57) ABSTRACT

Systems and methods for autonomous online payments to an individual are described. A request to generate an electronic payment user interface associated with an individual for a transaction to an account associated with an entity is received. One or more individual defined criteria associated with the electronic payment user interface for the transaction is received. An Internet accessible address to the electronic payment user interface is generated. A request input from a payer to access, via the Internet accessible address, the electronic payment user interface associated with the individual is received. An authorization input from the payer to make an electronic payment of monetary funds from an account of the payer to the account of the individual is received, and access by the individual to personally identifiable information of the payer regarding the transaction is prevented.

### CROSS REFERENCE TO RELATED APPLICATIONS

This application is a continuation of and claims priority to U.S. application Ser. No. 12/778,274, filed May 12, 2010, and entitled “Anonymous Electronic Payment System,” the entirety of which is incorporated herein by reference.

### BACKGROUND

Monetary payments may be a transactional payment, such as for purchasing a product or service, may be a gift payment, such as for a reward or an accomplishment, or may be for a charitable payment, such as for a school fund raiser or national organization. Making monetary payments, whether for transactional, gift, or charitable purposes, may be done in any of a number of different manners. One manner for monetary payment that has become increasingly popular with the advent of computer systems is by electronic payment.

Computers allow a user to make monetary payments in response to a bill, such as a utility bill or credit card bill, received from a transactional related entity. Upon receipt of a utility bill in the mail from a user's local gas company, the user can log into her account with a financial entity and make an electronic payment to the local gas company to pay for the bill. The account of the user at the financial entity may make a record of the transactional payment to note transfer of monetary funds from the account of the user to the local gas company. In such a scenario, the gas company receives a check from the financial entity in the name of the user that has the account, and the local gas company deposits the check in some manner to its own account. If the local gas company has an account at the same financial entity, the monetary funds may simply transfer directly from the account of the user to the account of the local gas company with the local gas company receiving some notice of the payment by the user in response to the bill and the deposit of the corresponding monetary funds into the account of the local gas company.

Yet, in the various electronic payments systems, a consumer making the payment, a payer, is required to divulge some form of personally identifiable information to the person/entity receiving the electronic payment, a payee. There is currently no manner for an individual to make an electronic payment to others in an online environment without giving away some form of personally identifiable information.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present disclosure are directed to a method and system for autonomous online payments to an individual. A request to generate an electronic payment user interface associated with an individual for a transaction to an account associated with an entity is received. One or more individual defined criteria associated with the electronic payment user interface for the transaction is received. An Internet accessible address to the electronic payment user interface is generated. A request input from a payer to access, via the Internet accessible address, the electronic payment user interface associated with the individual is received. An authorization input from the payer to make an electronic payment of monetary funds from an account of the payer to the account of the individual is received, and access by the individual to personally identifiable information of the payer regarding the transaction is prevented.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is an illustrative block diagram of a system for electronic payment that may be used to implement the processes and functions of certain embodiments of the present disclosure in accordance with at least one aspect of the present disclosure;

FIG. 4 is a flowchart of an illustrative method for electronic payment in accordance with at least one aspect of the present disclosure;

FIG. 5 is a flowchart of an illustrative method for setup of an electronic payment request by a payee in accordance with at least one aspect of the present disclosure;

FIG. 6 is a flowchart of an illustrative method for electronic payment by a payer in accordance with at least one aspect of the present disclosure;

FIG. 7 is a flowchart of an illustrative method for setup of an electronic payment request by a payee and payment of an electronic payment by a payer in accordance with at least one aspect of the present disclosure;

FIG. 8 is an illustrative user interface for generation of an electronic payment web page in accordance with at least one aspects of the present disclosure;

FIG. 9 is an illustrative user interface for accessing an electronic payment web page in accordance with at least one aspect of the present disclosure; and

FIG. 10 is an illustrative block diagram of a system for electronic payment that may be used to implement the processes and functions of certain embodiments of the present disclosure in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

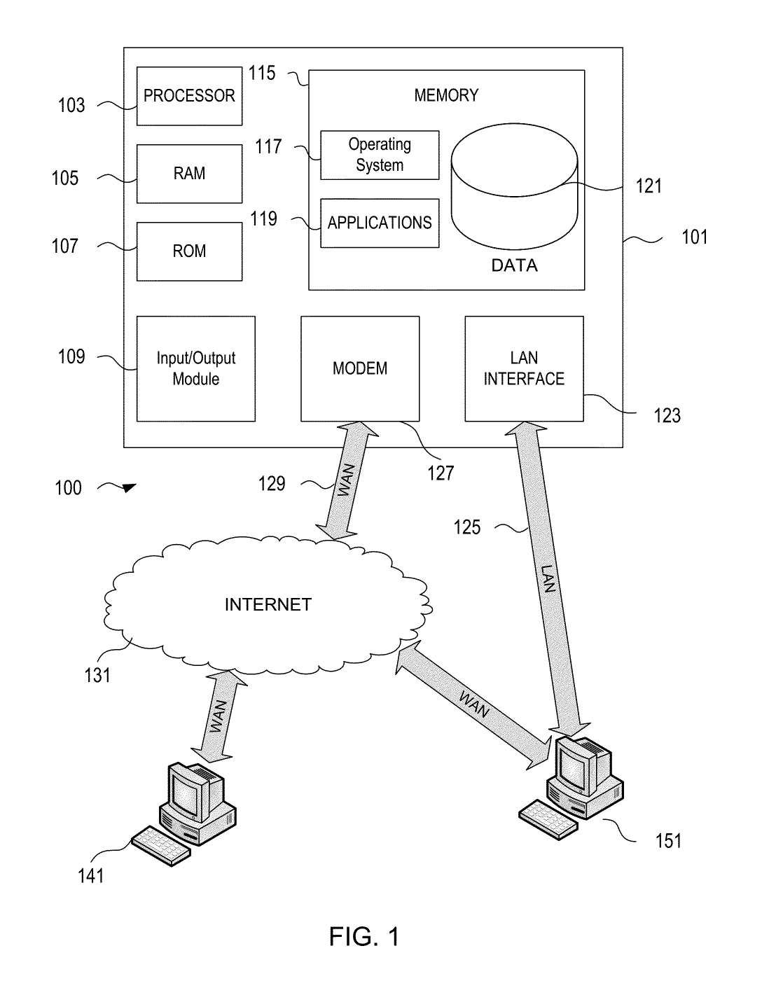

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the server 101 according to an illustrative embodiment of the disclosure may include computer executable instructions for invoking functionality related to providing access authorization for facilities and networks.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and the like, that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

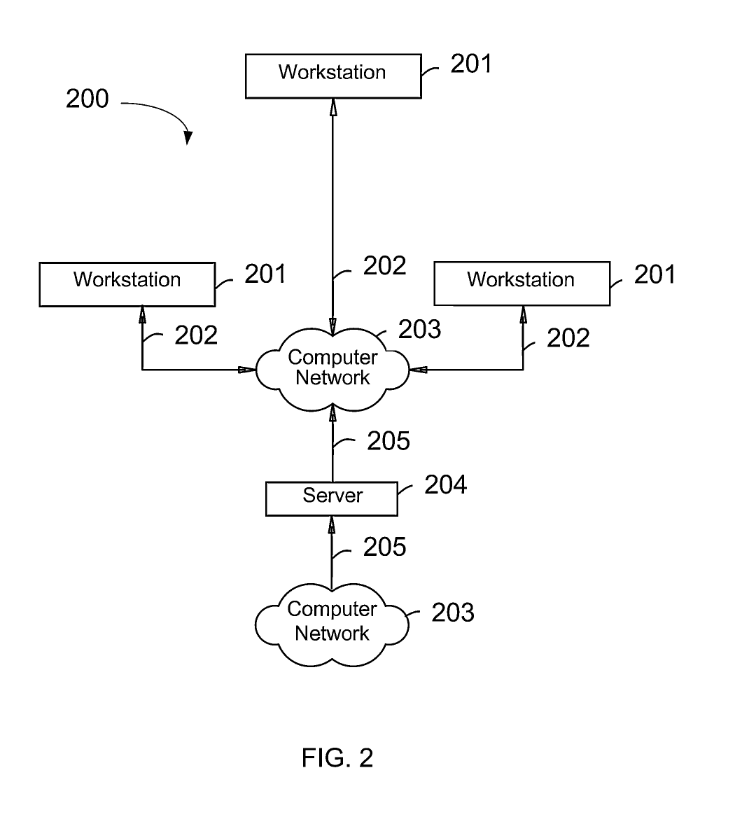

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, and the like.

The steps that follow in the Figures may be implemented by one or more of the components in FIGS. 1 and 2 and/or other components, including other computing devices.

Aspects of the present disclosure are directed to methods and systems for anonymous electronic payments in an online environment. Embodiments of the present disclosure accept online payments without requiring the payers, the individuals making electronic payments, to disclose to a payee, the receiver of monetary funds of the electronic payments, their real names or any other personally identifiable information. An individual, payee, may use an interface to create a web page that allows others, payer(s), to pay a payee online anonymously.

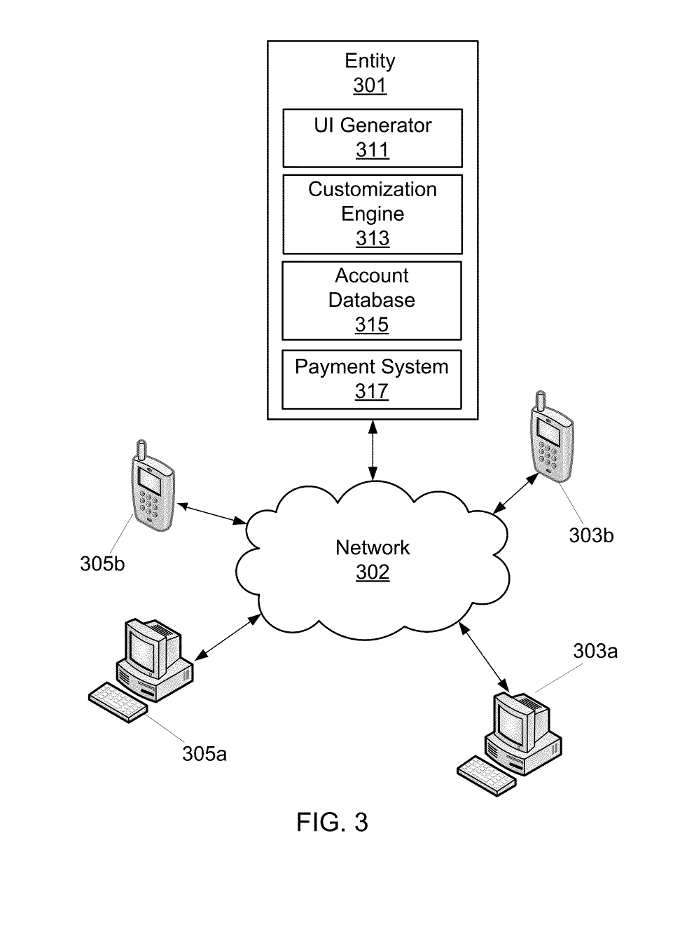

FIG. 3 is an illustrative block diagram of a system for electronic payment that may be used to implement the processes and functions of certain embodiments of the present disclosure in accordance with at least one aspect of the present disclosure. The anonymous electronic payment system of FIG. 3 includes an entity 301. Entity 301 may be a company offering a service to its customers in accordance with the features described herein. For example, entity 301 may be a financial entity with customers having checking and/or savings accounts with the financial entity.

Entity 301 is shown to include a number of subsystems. User interface (UI) generator 311 is one such subsystem. UI generator 311 is a subsystem configured to generate a web page for an individual, such as a payee, desiring to use a service for anonymous online electronic payment to an account of the payee. Payees 303a and 303b may be a single customer of the entity 301 that may access the UI generator 311 subsystem by way of a desktop computer 303a and/or by way of a terminal device 303b, such as a browser-capable smart phone. In another example, payees 303a and 303b may be different customers that may access his/her respective accounts and the service of the anonymous online electronic payment system. As described more fully below, UI generator 311 allows a payee, an individual seeking to receive monetary funds of anonymous electronic payments, to setup a UI for a web page for other individuals to access and make anonymous payments.

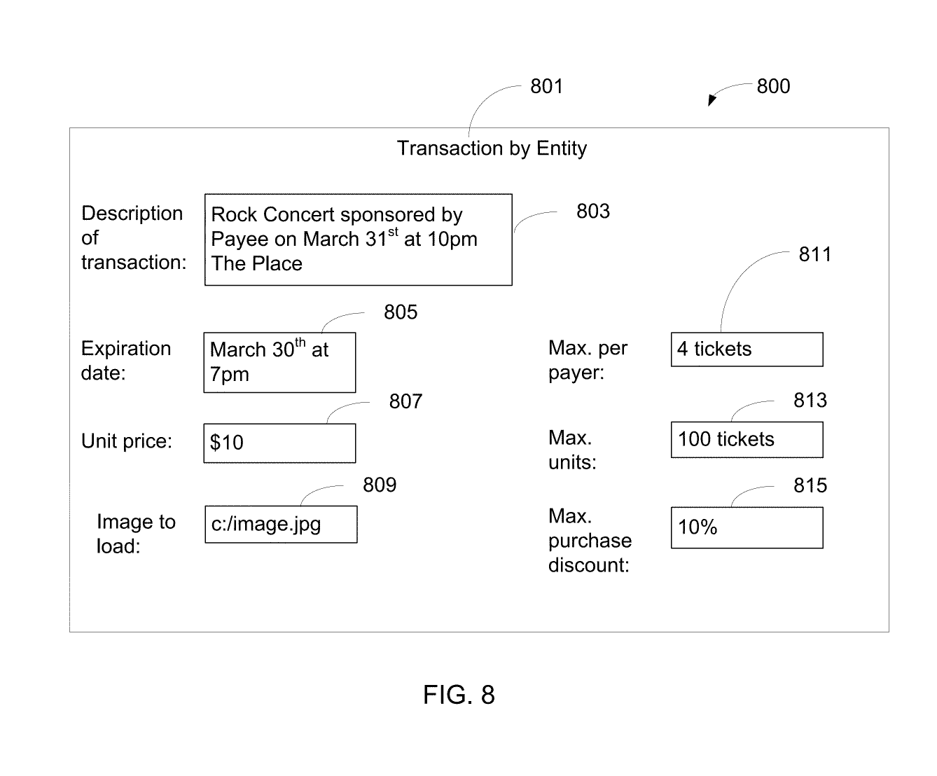

UI generator 311 may include software configured to guide a payee through the process for generating a UI for a transaction of the payee. Any of a number of different manners for generation of such a UI and associated web page may be utilized, some of which are described in more detail herein. In accessing the UI generator 311, a payee 303a may create the UI that may be accessed by others, payers 305a and/or 305b, to make the anonymous electronic payments. A payee may generate a default UI for a web page or, as described in more detail with respect to FIG. 8, a payee may generate a customized UI utilizing UI generator 311.

Upon initiation to generate and store a payee associated UI, UI generator 311 may be configured to generate an Internet address, such as a universal resource locator (URL), for accessing the electronic payment UI in an online environment, e.g., over the world wide web. UI generator, as described herein, may send the payee the Internet address, e.g., the URL, to the web page for dissemination to one or more potential payers.

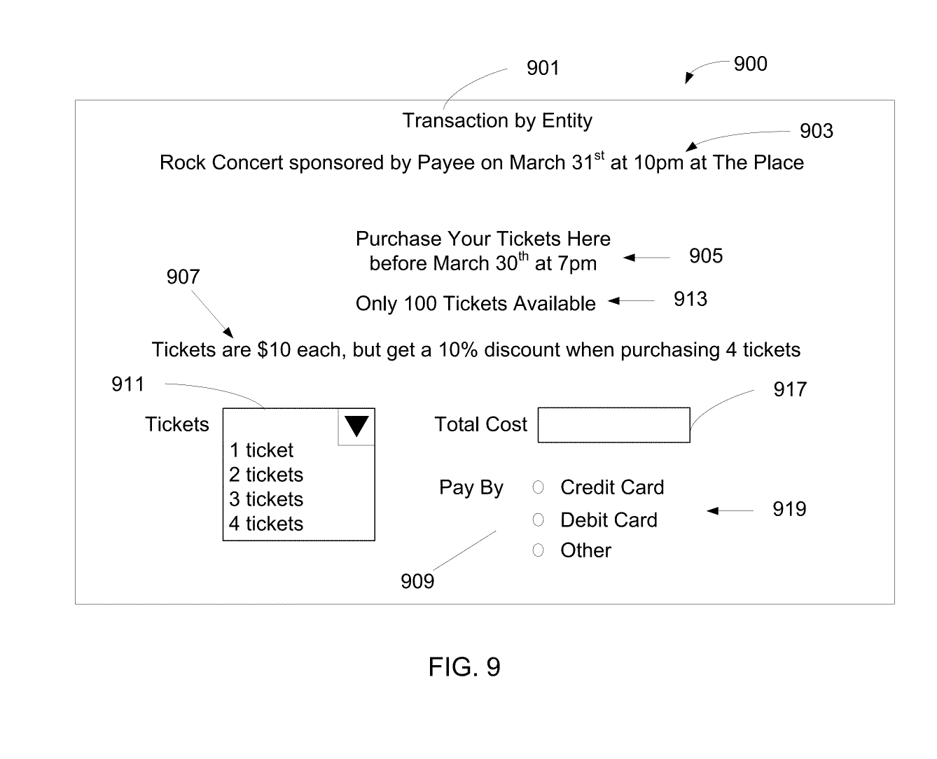

Entity 301 further includes a customization engine 313. Customization engine 313 is a subsystem configured to allow for customization of a web page for a payee desiring to use a service for anonymous online electronic payment to an account of the payee. Customization engine 313 allows a payee to create one or more individually defined criteria associated with the UI for a transaction. As described below with respect to FIG. 8, a payee may utilize customization engine 313 to setup user defined criteria for when the offer of the transaction will expire, how many units a single payer may purchase with respect to the transaction, how much a single unit will cost, if there are any discounts, and the like. Any of a number of user defined criteria may be implemented in any of a number of user defined manners. For example, a payee may desire to have the number of unit options for purchase to be shown in a drop down box, such as reference element 911 shown in FIG. 9.

Having customized the UI by utilizing customization engine 313, UI generator 311 may provide the payee with the Internet address to the UI. The Internet address may be a URL directing a web browser to a web page of a server that includes the customized web page of the payee. With the URL link to the UI of the payee, the payee may disseminate the URL to one or more payers for receiving electronic payments.

Entity 301 also includes an account database 315. Account database 315 is a subsystem configured to maintain accounts of payees, e.g., customers, 303a, 303b of the entity 301. In the example where the entity 301 is a financial entity, payee 303a may have a checking account with the financial entity 301. Payee 303b may have a checking account and a savings account with entity 301. Account database 315 maintains data on a respective account, such as names of authorized individuals associated with the account, amount of monetary funds currently in the account, restrictions for deposit or withdrawal on the account, passwords and other security provisions, routing number, entity account number, and the like. Account database 315 may be utilized for authentication of an individual identifying herself as an authorized individual associated with an account. In addition, as described in more detail below, account database 315 may be utilized for deposit of monetary funds into and/or out of an account of an authorized individual and/or for authentication of an authorized individual to do the same.

Entity 301 further includes a payment system 317. Payment system 317 is a subsystem configured to receive and process requests for electronic payments to be made from one account to another account. Payment system 317 may utilize account database 315 for processing of requests of a payer 305a and/or 305b to make an anonymous electronic payment as described herein. Payment system 317 may be used to verify the authorized transfer of monetary funds by a payer. For example, as described below, a payer may desire to make an anonymous electronic payment by using a credit card of the payer. Payment system 317 may be utilized to ensure that the payer is allowed to make an electronic payment based upon one or more user defined criteria of the UI of the system. Thus, if a payer desires to exceed the amount of monetary funds allowable by the UI of the payee, payment system 317 may prevent the transfer of monetary funds as not being in compliance with the payee defined criteria.

Payment system 317 may perform operations for charging a credit card account of a payer and/or may perform operations for transferring at least a portion of the charged monetary funds to a payee associated with the UI. As described below, payment system 317 may be configured to charge a fee for the service and thus all of the monetary funds authorized for transfer to the payee are transferred to an account of the payee less the fee for the service. Still further, as described herein, the monetary funds of the payer may be maintained for a predetermined period of time and then transferred to the payee. During the predetermined time period, any interest accrued in maintaining the monetary funds may be transferred to the entity for the service. Thus, the principal of the transferred monetary funds of the payer may be received by the payee, just after a predetermined time period, such as 48 hours.

As described herein, entity 301 may interact with a payee, such as payee 303a, and a payer, such as payer 305a, and may maintain personally identifiable information with respect to both; however, entity 301 is configured to prevent access by a payee to personally identifiable information of the payer regarding the transaction associated with the UI of the payee. As such, a payer is assured of an anonymous electronic payment to the payee and the payee. For example, such a service may be desirable for payer to make an anonymous gift to a payee. As described below, a payee does not receive any name, account information, address, online alias, IP network address, email address, or other personally identifiable information regarding the payer that may be utilized in identifying the payer.

Entity 301 is shown connected to payees 303a and 303b and payer 305a and 305b over a network 302. Payers 305a and 305b may be a single individual that may access UI of the payee by way of a desktop computer 305a and/or by way of a terminal device 305b, such as a browser-capable smart phone. In another example, payers 305a and 305b may be different payers that may access the anonymous online electronic payment system of the payee. Network 302 may include one or more networks interconnected in an online environment, such as the World Wide Web. Network 302 may include the Internet. Network 302 may include wired and wireless systems for interconnecting a payee 303a, an entity 301, and a payer 305b. Network 302 may include internal networks to an entity, a payer, and/or a payee, and/or external networks to the entity, payer, and/or the payee. As a result, the anonymous online electronic payment service described herein may be used anywhere and at anytime.

Although subsystem 311, 313, 315, and 317 are shown within entity 301, it is understood that one or more of these subsystems may be located in physically separate areas and, in addition, one or more of these subsystems may be operated by one or more other individuals and/or entities. In such a case where different entities performed the subsystem operations, entity 301 would be the group of those entities or one entity controlling the operation of the other entities.

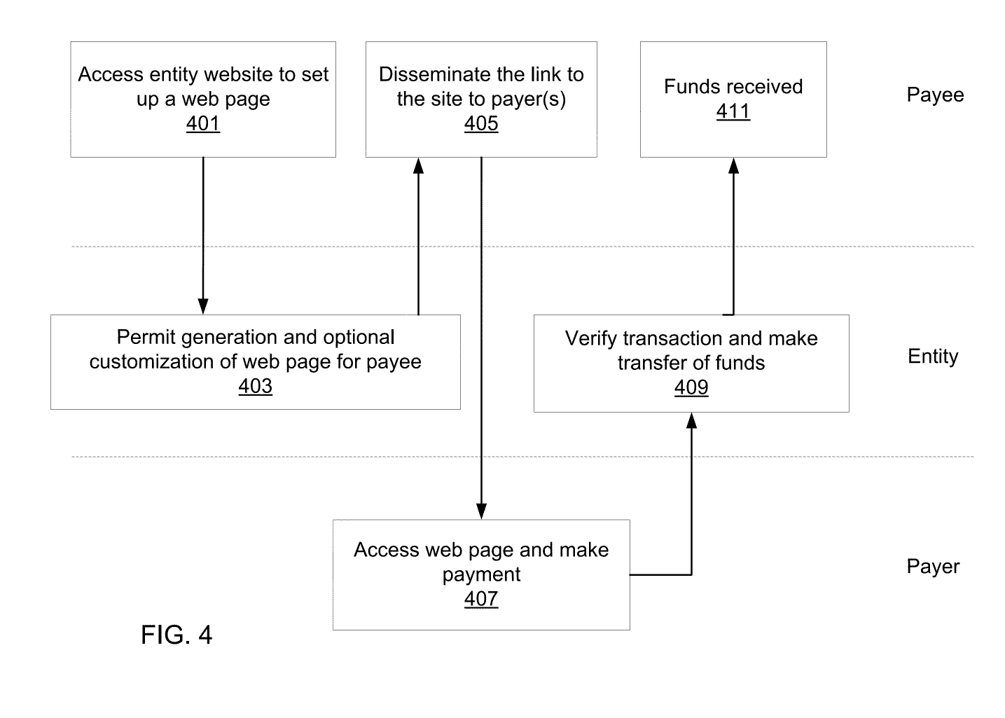

FIG. 4 is a flowchart of an illustrative method for anonymous electronic payment in accordance with at least one aspect of the present disclosure. The dashed lines indicate operational aspects between a payee, an entity, and a payer for the example of FIG. 4. The description of FIG. 4 will coincide with an illustrative example of implementation of the steps in FIG. 4; however, it should be understood that this is but one illustrative example. The illustrative example is a payee that is having a cookout out her house over the weekend and is looking to get others to help pay for her costs in having the cook out.

In 401, a payee may access an entity website online in order to set up an electronic payment web page for the payee that is for a transaction. In this case, the entity website may be a financial entity where the payee is a customer with a checking account. The transaction is the cookout and payment for costs associated with the cookout. In accessing the electronic payment web page, the entity in 403 may permit generation of the payee user interface (UI) for the transaction. Such permission may be based upon an authentication of the payee as an authorized individual associated with an account associated with the entity. For example, in accessing the entity website, the payee may have to enter a form of identification and corresponding password.

In generating the UI for the payee, a default UI may be utilized where customization is not needed. In another embodiment, the entity optionally may allow for customization of the UI as part of the web page. In the example of the cookout, the payee may desire to indicate the time and location of the cookout and a request for attendees to help pay. In order to ensure that no one attendee pays for the entire cookout cost, the payee may include a payee defined criteria that limits the amount of monetary funds a single payer may transfer. In addition, the payee may desire to cap the total amount of monetary funds by all payers that may be transferred to the total amount of cost of the cookout. As such, the cost for the cookout may be $100 in total and the payee may set a limit of $100 in total transfers. After the limit is reached, the system may prevent other potential payers from making further transfers.

Any of a number of these and other payee defined criteria associated with the electronic payment UI for the transaction may be entered by a payee in setting up the UI. Other types of payee defined criteria may include an upper and/or lower threshold for transfer by a single payer, a maximum amount of transfer by all payers, an expiration point, such as a date and time for transfers to occur before, a total amount of units that may be purchased, a unit amount versus an aggregate amount, notes that may be inputted by a payer, a discount for some reasons, such a number of units purchased, and other criteria.

Upon completion of the customized features and generation of the UI and corresponding web page for the payee, the entity may generate an Internet accessible address, such as a universal resource locator (URL) link, to the customized UI of the payee for the transaction. The generated URL may be sent to the payee. In 405, the payee then may disseminate the URL link to the web site to payers. For example, the payee may invite 30 people to the cookout and have email address for the 30 people. In 405, the payee may send an email that includes the URL link to the payee UI for the cookout transaction. In the example of the cookout, the payee may send directly to 30 known people by an email address; however, other examples include a broadcast of the URL by means of a blog or web site used by the payee that may be accessed by anyone.

In 407, one or more payers have received the email with the URL link. A payer may access the web page with the customized payee UI via the URL link. Such a case may be a payer clicking on the URL link and having the payer's web browser launch a request to the web site of the entity to access the customized UI of the payee. The payer may decide to want to help pay for the cost of the cookout and may want to anonymously pay. As such, accessing the customized UI web page, the payer may input an authorization for transfer of monetary funds from an account of the payer to the payee. In this example, the payer may want to charge $10 to a credit card of the payer and have the $10 go to the payee for the cookout transaction.

Proceeding back to the entity in 409, the entity may verify the transfer of monetary funds, such as confirming the correct entry of credit card number and expiration date for the credit card, and then make the monetary fund transfer to the account of the payee. Since the payee is a customer of the financial entity in this example, the financial entity transfers the funds charged to the payer's credit card to the checking account of the payee. Then, in 411, the monetary funds of the transfer are received by the payee and may be utilized for paying for the cost of the cookout. However, the payee, at no time in the processing of the transaction, receives any name, account information, address, online alias, IP network address, email address, or other personally identifiable information regarding the payer that may be utilized in identifying the payer. Any personally identifiable information of the transfer of funds is maintained by the entity and none is forwarded to the payee. Should the entity provide a transfer receipt to the payee, no personally identifiable information of the payer is provided to the payee in such an illustrative receipt.

An entity implementing a service including one or more aspects of the present disclosure as described herein may charge a fee for use of such a service. A fee may be charged against the payer as part of the transfer of monetary funds, the payee as part of the initial UI generation request and/or the receipt of transferred monetary funds from payers, and/or from some combination of both. In one example, no fee may be charged but interest accrued from transfer by a payer prior to transfer to the payee may be retained by the entity to offset costs for implementing such a service. Such a service also provides an entity numerous cross-sell opportunities. A payer may not be a customer of the entity and, when a payer accesses a payee's customized UI, advertisements and/or messages may be provided to entice the payer into seeking an account with the entity.

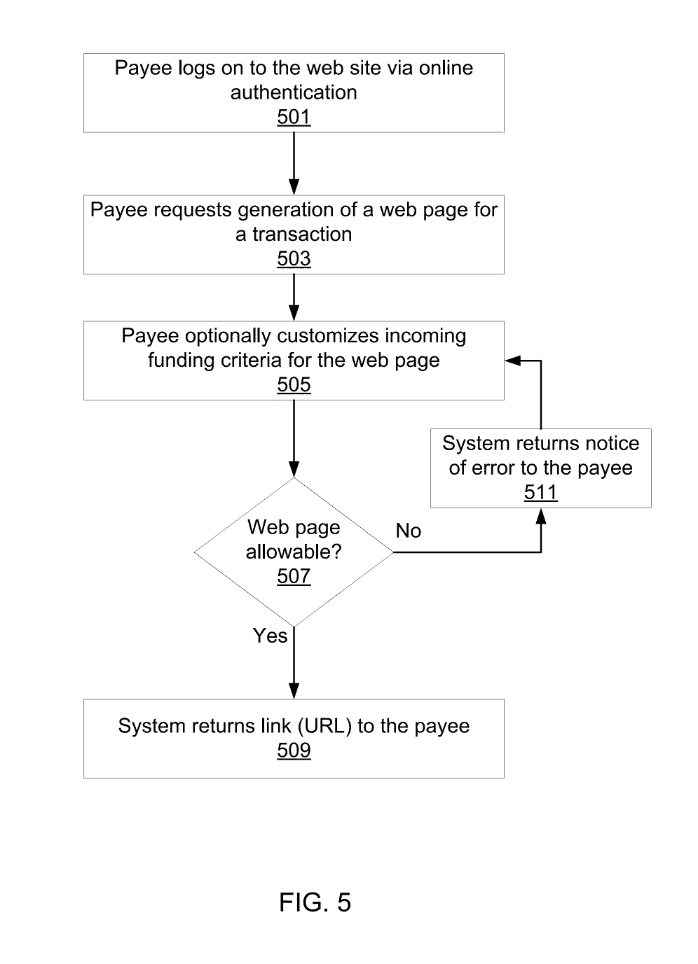

FIG. 5 is a flowchart of an illustrative method for setup of an electronic payment request by a payee in accordance with at least one aspect of the present disclosure. In 501, a payee logs on to a web site of an entity via an online authentication system. Such an example may be a customer of a financial entity accessing a web site of the financial entity and entering an online identification (ID) and corresponding password. Once authenticated, in 503, the payee requests generation of a web page for a transaction. The request for generation of the web page may be for transfer of funds to an account of the payee associated with the entity. In 505, the payee optionally customizes the incoming funding criteria for the web page of the payee. In 505, the payee may input one or more payee defined criteria regarding the incoming monetary funding associated with the transaction. Such criteria may include unit price, maximum allowable units for purchase, and expiration point for transfers of monetary funds by payers to occur.

From 505, the process may proceed to 507 where a determination is made as to whether the web page is allowable by the entity for completion. For example in 507, the entity may confirm that proper information, such as unit amounts, account number of the payee, expiration date for the transaction, and the like, has been entered by the payee. If the web page is found to not be allowable in 507, the process may move to 511 where the entity may return a notice of error to the payee. Such a notice may be a visual message on a display screen to the payee indicating the specifics of the error, such as a failure to enter a proper expiration point, e.g., the payee entered a date and time that has already passed. Following 511, the process may proceed back to 505 where a payee may correct the error by entering in modified and/or additional criteria. If the web page is found to be allowable by the entity in 507, the process may proceed to 509 where an Internet accessible address, such as a URL link, may be generated to correspond to the customized web page and the URL link may be returned to the payee for dissemination to payers. With the customized web page generated and linked to a URL, the set-up process of the example of FIG. 5 may be complete.

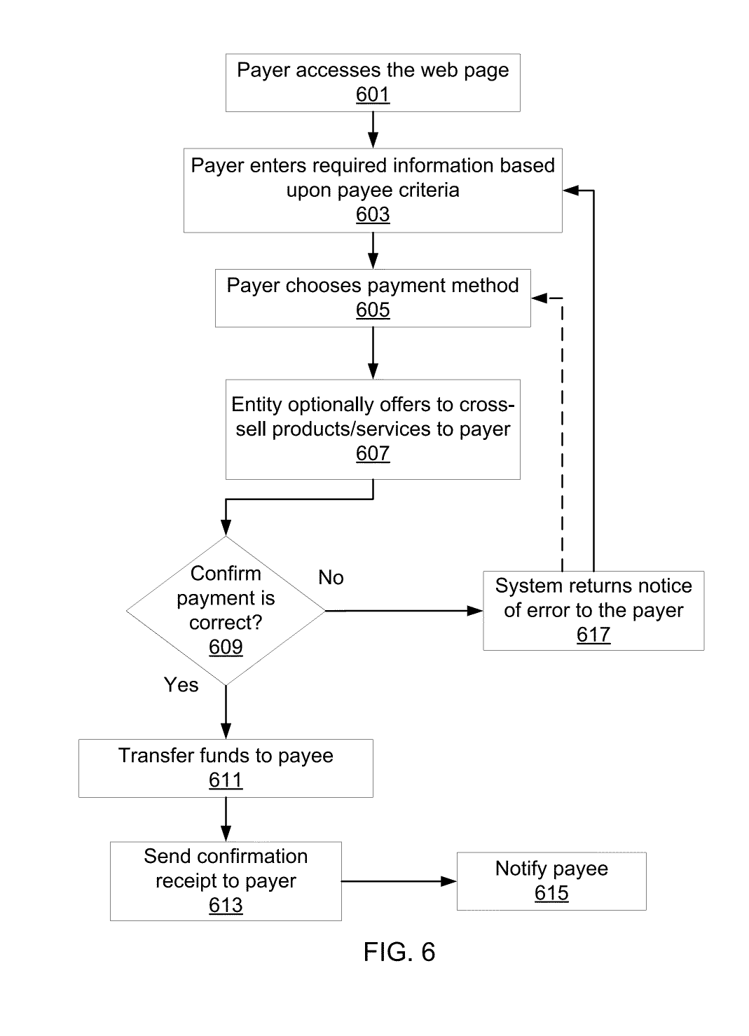

FIG. 6 is a flowchart of an illustrative method for electronic payment by a payer in accordance with at least one aspect of the present disclosure. The process starts and at 601, a payer may request access to a customized UI web page of a payee. The access may be based upon accessing an Internet accessible address, such as a URL, that the payee sent to the payer and/or broadcast and the payer found/received. One example of a payee directly transmitting a URL link may be a situation where the payee emails the URL link to the payer. An example of a payee broadcasting a URL link may be a situation where the payee includes the URL link as part of a blog or on some other web page that anyone may access.

Having accessed the customized UI web page of the payee, in 603, the payer may enter required information based upon one or more payee defined criteria regarding the transaction. For example, the payer may have to enter a total number of units to purchase. Having entered the required information in 603, the process moves to 605 where the payer chooses a payment method for authorizing transfer of monetary funds from an account of the payer to the payee. Such a situation may be where the payer enters a choice between a credit card, a debit card, or some other authorized manner. For example, another authorized manner may be when the payer also is a customer of the entity. In such an example, monetary funds may be directly transferred from an account of the payer with the entity to the account of the payee with the entity.

Proceeding to 607, the entity optionally may offer to cross-sell products and/or services to the payer. One example may be a situation where a transfer of monetary funds by the payer comes with a fee involved. When offering a product to the payer, if purchased or initiated, the fee may be lowered and/or waived. Therefore, if the payer is not a customer of the entity, an offer may be made to the payer to open an account with the entity. If done, the fee for the monetary funds transfer to the payee may be waived.

The process moves to 609 where a determination may be made as to whether the payment of monetary funds is confirmed as correct. For example, in 609, the system may determine that the expiration date provided by the payer for a credit card to charge to is not correct. In such a case, the system may return a notice of error to the payer in 617. Such a notice may be a visual message on a display screen to the payer indicating the specifics of the error, such as a failure to enter a proper expiration date for the credit card. Following 617, the process may proceed back to 603 and/or 605 where a payer may correct the error by entering in modified and/or additional information. If the payment of monetary funds is confirmed as correct in 609, the process moves to 611.

In 611, the monetary funds authorized by the payer are transferred to the payee. The transfer to the payee may be made to an account of the payee associated with the transaction of the customized UI set up by the payee when initially customizing the UI. In 613, a confirmation receipt may be sent to the payer to confirm the authorized transfer and information regarding the same. In 615, the payee may receive some form of notification of the payment. However, the payee, at no time in the processing of the transaction, receives any name, account information, address, online alias, IP network address, email address, or other personally identifiable information regarding the payer that may be utilized in identifying the payer. Any personally identifiable information of the transfer of funds is maintained by the entity and none is forwarded to the payee. Should the entity provide a transfer notification to the payee, such as in 615, no personally identifiable information of the payer is provided to the payee in such an illustrative notification.

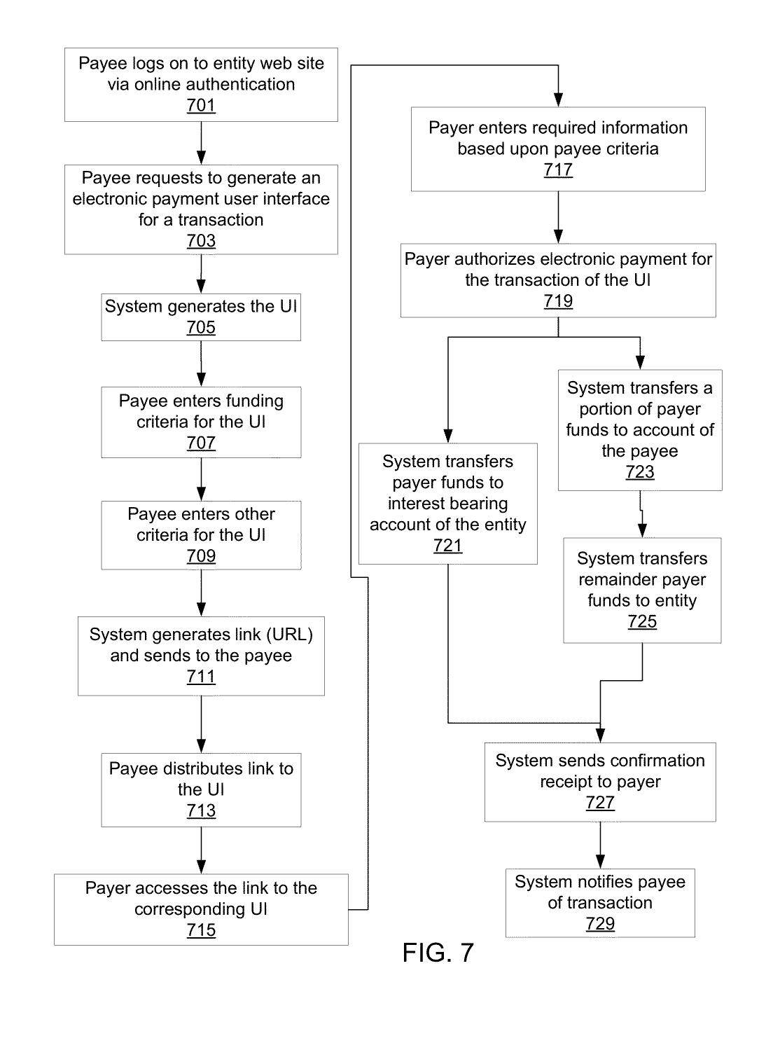

FIG. 7 is a flowchart of an illustrative method for setup of an electronic payment request by a payee and payment of an electronic payment by a payer in accordance with at least one aspect of the present disclosure. The description of FIG. 7 will coincide with an illustrative example of implementation of the steps in FIG. 7; however, it should be understood that this is but one illustrative example. The illustrative example is a payee that is advertising a rock concert at a specific time and location and is looking to sell tickets to the event to others.

The process starts and at 701 a payee logs on to a web site of an entity via an online authentication system. Such an example may be a customer of a financial entity accessing a web site of the financial entity and entering an online identification (ID) and corresponding password. In the rock concert example, the payee is a customer of a financial entity and she logs into her online account with the financial entity via an ID and a password. Once authenticated, in 703, the payee requests generation of a web page for a transaction. The request for generation of the web page may be for transfer of funds to an account of the payee associated with the entity. As part of the home web page of the financial entity, a link may be included to allow a customer/payee to initiate a request to generate a payee web page with UI for a transaction. In the example, the payee may click on the link initiating the request to generate an electronic payment user interface for the transaction. The transaction is the ticket charge for the concert.

In 705, the system generates the electronic payment user interface for the payee associated with an account of the payee. In the example, the payee is a customer of the financial entity and has a checking account with the financial entity. The system may associate the electronic payment UI with the checking account. FIG. 8 is an illustrative user interface 800 for generation of an electronic payment web page in accordance with at least one aspect of the present disclosure. User interface 800 may be the UI developed by the payee in the example of a rock concert.

Returning to FIG. 7, in 707, the payee may input one or more payee defined criteria regarding the incoming monetary funding associated with the transaction. In 709, the payee may input one or more other payee defined criteria regarding the transaction. Such criteria for 707 and/or 709 may include a description of the rock concert event, as shown by 803 in FIG. 8, unit price, as shown by 807 in FIG. 8, maximum allowable units for purchase by a single payer, as shown by 811 in FIG. 8, maximum allowable units for purchase overall, as shown by 813 in FIG. 8, one or more images that a payee may want to include in her customized UI, as shown by 809 in FIG. 8, any applicable discounts, as shown by 815 in FIG. 8, and an expiration point for transfers of monetary funds by payers to occur, as shown by 805 in FIG. 8.

From 709, although not shown, the process may determine whether the customized UI is allowable by the entity for completion. The entity may confirm that proper information, such as unit amounts, account number of the payee, expiration date for the transaction, and the like, has been entered by the payee. If the UI is found to not be allowable, the entity may return a notice of error to the payee. Such a notice may be a visual message on a display screen to the payee indicating the specifics of the error, such as a failure to enter a proper expiration point, e.g., the payee entered a date and time that has already passed. The process may proceed back to 707 and/or 709 where a payee may correct the error by entering in modified and/or additional criteria. If the web page is found to be allowable by the entity, the process may proceed to 711 where an Internet accessible address, such as a URL link, may be generated to correspond to the customized UI and the URL link may be returned to the payee for dissemination to payers.

In 713, the payee may distribute the URL link to the customized UI generated in 711. In the example of the rock concert, the distribution in 713 may be a broadcast of the URL link by the payee on a web site associated with the band performing at the rock concert. The URL link may be included as a clickable hyperlink to the customized UI of the payee. Proceeding to 715, a payer may request access to the customized UI of a payee for the rock concert. Having accessed the web page of the band performing at the rock concert, the payer may click on the URL link to access the customized UI of the payee.

Having accessed the customized UI of the payee, in 717, the payer may enter required information based upon one or more payee defined criteria regarding the rock concert transaction. For example, the payer may have to enter a total number of tickets to purchase. Having entered the required information in 717, the process moves to 719 where the payer chooses a payment method for authorizing transfer of monetary funds from an account of the payer to the payee. Such a situation may be where the payer enters a choice between a credit card, a debit card, or some other authorized manner, as illustratively shown in reference element 919 in FIG. 9.

Although not shown in FIG. 7, the process at 719 may include a determination as to whether the payment of monetary funds by the payer is confirmed as correct. For example, the system may determine that the expiration date provided by the payer for a credit card to charge to is not correct. In such as case, the system may return a notice of error to the payer. Such a notice may be a visual message on a display screen to the payer indicating the specifics of the error, such as a failure to enter a proper expiration date for the credit card. Following such an error determination, the process may proceed back to 717 and/or 719 where a payer may correct the error by entering in modified and/or additional information.

Following 719, the process may proceed to 721 where the system transfers the monetary funds authorized by the payer in 719 to an interest bearing account of the entity. The monetary funds in the interest bearing account may be maintained for a predetermined time period. Upon expiration of the predetermined time period, the system may transfer the amount of the monetary funds authorized by the payer to the account of the payee associated with the customized UI. As part of the service of the customized UI, any interest accrued on the monetary funds while being maintained by the entity may be retained by the entity. As such, in the example of the rock concert, the payee receives the same amount of monetary funds transferred by the payer and the entity retains any accrued interest. The predetermined time period may correlate to the expiration date of the transaction of the customized UI. In the rock concert example of FIGS. 8 and 9, the expiration point is shown as March 31^{st} at 7 pm by reference elements 805 and 905. The predetermined time period may expire on the expiration point. Any monetary funds received from payers before this time may be maintained in an interest bearing account and the interest accrued before March 31^{st} at 7 pm is retained by the entity. Following 721, the process proceeds to 727.

Alternatively to 721, the process may proceed from 719 to 725. In 725, the system transfers a portion of the monetary funds authorized by the payer in 719 to an account of the payee associated with the entity. For the rock concert example, a fee may be associated with the customized UI service. All of the monetary funds authorized for transfer by the payer, such as $20, may be transferred to the account of the payee in 723, less a service fee. The payee may receive $18 of the original $20 and $2 is the service fee. In 725, the remainder portion of the monetary funds, e.g., the $2 service fee, is transferred to the entity. From 725, the process proceeds to 727.

In 727, a confirmation receipt may be sent to the payer to confirm the authorized transfer and information regarding the same. In 727, a payer may receive some form of ticket to the rock concert as well. The ticket may be a barcode that may be scanned at the rock concert location for entry to the concert. In 729, the payee may receive some form of notification of the payment. For example, the payee may receive notification that 2 more tickets have been sold and that a total of 52 tickets have thus far been sold leaving 48 other tickets still available for sale. However, the payee, at no time in the processing of the transaction, receives any name, account information, address, online alias, IP network address, email address, or other personally identifiable information regarding the payer that may be utilized in identifying the payer. Any personally identifiable information of the transfer of funds is maintained by the entity and none is forwarded to the payee. Should the entity provide a transfer notification to the payee, such as in 729, no personally identifiable information of the payer is provided to the payee in such an illustrative notification.

As should be understood, the examples provided here are with respect to a single payer. However, the features of the present disclosure may be utilized by a plurality of different payers. In the example of the rock concert, any of a number of different individual payers may purchase tickets and authorize the transfer of monetary funds. The examples provided with respect to a single payer are merely for illustrative purposes.

FIG. 8 is an illustrative user interface 800 for generation of an electronic payment web page in accordance with at least one aspect of the present disclosure. UI 800 may be seen by a payee in customization of the electronic payment UI of the payee. The payee may enter any of a number of various payee defined criteria regarding UI elements in any of a number of known manners. In the UI 800, a logo 801 of the entity may be shown for advertisement purposes. In area 803, a payee may enter a description of the transaction for the benefit of the payers. Although shown as a number of text boxes for entry of text, the system may be configured to provide a number of predefined templates where certain fields are prearranged and others are not.

In areas 805, 807, 809, 811, 813, and 815, the payee may enter additional payee defined criteria for inclusion in the customized electronic payment UI that is seen by a payer, such as illustratively shown as reference element 900 in FIG. 9. In area 805, a payee may enter an expiration date identifying the point where monetary funds may no longer be transferred and/or when the payee customized UI will no longer be accessible by payers. In area 807, a unit price per item, such as a per ticket price, may be entered by the payee. Area 811 allows a payee to enter a maximum number of tickets that any individual payer may purchase at one time and/or for the transaction.

Area 813 allows a payee to enter a maximum number of units, e.g., tickets, which are for sale to the event. In the example of a rock concert, fire codes may restrict the attendance to no more than 100 people. Thus, a maximum may be set in area 813 and, after the maximum number of tickets is sold, no additional tickets may be purchased and/or the access to the customized UI of the payee may be restricted. Area 815 allows a payee to enter a discount. In this example, the payee has indicated that a 10% discount on the cost of the tickets will be allotted upon purchase of the maximum 4 tickets by an individual payer. Thus, a payer may receive an incentive to purchase more tickets. In area 809, the payee may enter one or more images that may be loaded into one or more locations within the customized UI. In this example, the payee has identified a specific JPG file for inclusion in the customized UI.

FIG. 9 is an illustrative user interface for accessing an electronic payment web page in accordance with at least one aspect of the present disclosure. UI 900 may be seen by a payer in accessing a customized electronic payment UI of the payee. When accessing the UI 900, a logo 901 of the entity may be shown for advertisement purposes. One or more additional cross-sale advertisements may be included as well to encourage the payer to openly purchase a product or service with the entity. In area 903, the description of the transaction as entered by the payee in area 803 in FIG. 8 is shown. The description identifies the event, the time and date, and the location of the concert.

In areas 905, 907, and 913, information may be provided to the payer regarding the event. In this example, the payer is informed of the maximum number of tickets that may be sold, 100 tickets in 913, which corresponds to the payee defined criteria entered in area 813 in FIG. 8. In addition, in 905 the payer is informed of the expiration date for purchasing tickets, which corresponds to the payee defined criteria entered in area 805 in FIG. 8. In 907, the payer is informed of the price of a single ticket, $10, and the discount that the payer receives if purchasing 4 tickets to the event, a 10% discount. The price and discount correspond to the user defined criteria entered in areas 807 and 815 in FIG. 8.

A background image 909 is included in UI 900. Background image 909 may correspond to the image entered in area 809 in FIG. 8. As understood, any of a number of different images, movies, sound clips, and the like, may be utilized by a payee for inclusion in the customized UI 900 and that background image 909 is but one example. Area 911 is a drop down box that allows a payer to choose the number of tickets she desires to purchase for the rock concert event. The choices within area 911 of 1-4 tickets may correspond to the maximum number of tickets that an individual payer may purchase as defined by the payee in area 811 of FIG. 8. Upon choosing the desired number of tickets in drop down box 911, a total cost area 917 may show the calculated cost of the purchase to the payer. For example, the number of tickets may be multiplied by the ticket cost. If the payer purchases the maximum number of tickets, the discount of 10% may be applied as well. Taxes, service fees, and other charges may be applied here as well. Finally, in area 919, a payer may choose the method of payment for authorization of transferring monetary funds. One or more other UIs may appear in response to the choice made by the payer. For example, for a credit card, fields may be opened for a payer to enter a name on the credit card, a billing address, a credit card number, a security code number, and an expiration date on the card.

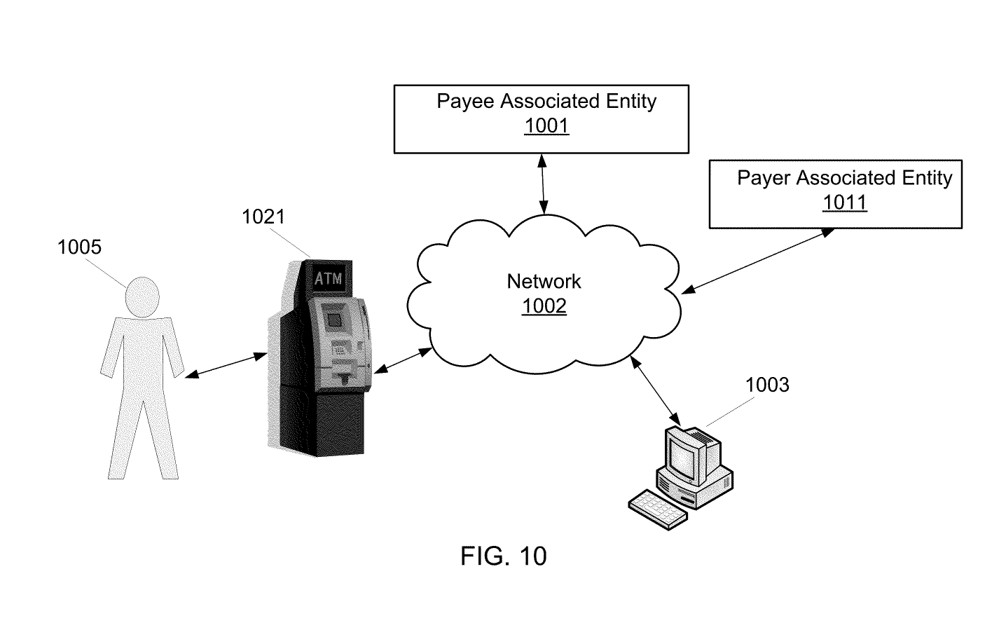

FIG. 10 is an illustrative block diagram of a system for electronic payment that may be used to implement the processes and functions of certain embodiments of the present disclosure in accordance with at least one aspect of the present disclosure. In FIG. 10, a payee associated entity 1001 and a payer associated entity 1011 are shown connected through a network 1002. Network 1002 may operate in a similar manner as network 302 shown in FIG. 3. Payee associated entity 1001 and payer associated entity 1011 may be the same or different financial entities, such as banks. Payee 1003 may access payee associated entity 1001 to generate a customized electronic payment UI. A payer 1005 may be aware of the customized UI of the payee. In the example of FIG. 10, a payer 1005 may access an ATM 1021 associated with the payer associated entity 1011. Upon accessing the ATM 1021, the payer 1055 may authorize transfer of the monetary funds from an account accessible via the ATM 1021.

In the example of FIG. 10, the entire process may not occur over the Internet. If the payee associated entity 1001 and the payer associated entity 1011 are the same financial entity, there may not be a need for operation over the Internet. In one example, the payee generated UI may be associated with a web site of the entity. Upon accessing the ATM 1021, the payer 1005 may access the payee generated UI. This access to the generated UI may be entirely within a network 1002 not operating with the Internet. Because the payee associated entity 1001 and the payer associated entity 1011 are the same entity, monetary funds may be transferred within the entity without a need for access with or through the Internet.

While illustrative systems and methods as described herein embodying various aspects of the present disclosure are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present invention.

What is claimed is:

1. A computer-implemented method comprising:
receiving, at a first computing device, a request from a first individual to generate an electronic payment user interface for a first transaction, wherein the first transaction comprises a transaction to the first individual's account, and wherein the account is managed by an entity;
receiving, at the first computing device, at least one criterion defined by the first individual, wherein the at least one criterion is associated with the electronic payment user interface for the first transaction;
generating, by the first computing device, an Internet accessible address to the electronic payment user interface;
receiving, at a second computing device, a request input from a second individual, different from the first individual, to access, via the Internet accessible address, the electronic payment user interface;
receiving, at the second computing device, an authorization input from the second individual to make an electronic payment of an amount of monetary funds from the second individual's account to the first individual's account; and
preventing access by the first individual to information that personally identifies the second individual,
wherein the at least one criterion comprises an expiration point specifying a date when monetary funds are no longer authorized for transfer into the first individual's account.

2. The method of claim 1, prior to receiving the request to generate the electronic payment user interface, the method further comprising authenticating the first individual as an authorized individual associated with first individual's account.

3. The method of claim 1, further comprising distributing, to the second individual, a receipt indicating the amount of monetary funds transferred through the electronic payment.

4. The method of claim 1, further comprising distributing, to the first individual, a confirmation of transfer, wherein the confirmation of transfer indicates the amount of monetary funds transferred using the electronic payment user interface.

5. The method of claim 1, wherein the at least one criterion, defined by the first individual, includes a threshold amount of monetary funds authorized for transfer into the first individual's account.

6. The method of claim 1, wherein the at least one criterion, defined by the first individual, includes a maximum amount of monetary funds authorized for transfer into the first individual's account.

7. The method of claim 6, wherein the maximum amount of monetary funds comprises a total amount of monetary funds received from a plurality of different individuals, wherein the total amount of monetary funds are received for the first transaction.

8. The method of claim 1, wherein the at least one criterion, defined by the first individual, includes a listing of a plurality of units for purchase associated with the first transaction.

9. The method of claim 1, further comprising generating the electronic payment user interface.

10. The method of claim 1, further comprising transferring a portion of the amount of monetary funds to the first individual's account.

11. The method of claim 1, wherein the electronic payment of the monetary funds comprises a first portion and a remainder portion of the monetary funds, the method further comprising:
transferring the first portion of the monetary funds to the first individual's account; and
transferring the remainder portion of the monetary funds to the entity.

12. The method of claim 1, further comprising:
responsive to receiving the authorization input from the second individual to make the electronic payment, transferring the amount of monetary funds from the second individual's account to the entity's interest bearing account;
upon expiration of a predetermined time period, transferring, from the entity's interest bearing account, monetary funds equal to the amount of monetary funds to the first individual's account.

13. The method of claim 1, further comprising:
receiving a second request input from a third individual, different from the first individual and the second individual, to access, via the Internet accessible address, the electronic payment user interface;
receiving a second authorization input from the third individual to make a second electronic payment of a second amount of monetary funds from the third individual's account to the first individual's account as part of the first transaction; and
preventing access by the first individual to information that personally identifies the third individual.

14. One or more non-transitory computer readable media comprising computer executable instructions that, when executed by at least one processor, causes the at least one processor to perform a method comprising:
receiving, from a first individual, a request to generate an electronic payment user interface for a first transaction, wherein the first transaction comprises a transaction to the first individual's account, and wherein the account is managed by an entity;
receiving at least one criterion, defined by a first individual, wherein the at least one criterion is associated with the electronic payment user interface for the first transaction;
generating an Internet accessible address to the electronic payment user interface;
receiving a request input from a second individual, different from the first individual, to access, via the Internet accessible address, the electronic payment user interface;
receiving an authorization input from the second individual to make an electronic payment of an amount of monetary funds from the second individual's account to the first individual's account;
preventing access by the first individual to information that personally identifies the second individual;
receiving a second request input from a third individual, different from the first individual and the second individual, to access, via the Internet accessible address, the electronic payment user interface;
receiving a second authorization input from the third individual to make a second electronic payment of a second amount of monetary funds from the third individual's account to the first individual's account as part of the first transaction; and
preventing access by the first individual to information that personally identifies the third individual,
wherein the at least one criterion comprises an expiration point specifying a date when monetary funds are no longer authorized for transfer into the first individual's account.

15. The one or more non-transitory computer readable media of claim 14, the method further comprising transferring at least a portion of the amount of monetary funds to the first individual's account.

16. The one or more non-transitory computer readable media of claim 14, further including instructions that, when executed, cause the processor to:
distribute, to the second individual, a receipt indicating the amount of monetary funds transferred through the electronic payment.

17. An apparatus, comprising:
at least one processor; and
at least one memory storing computer-readable instructions that, when executed by the at least one processor, cause the apparatus to perform:
receiving a request from a first individual to generate an electronic payment user interface for a first transaction, wherein the first transaction comprises a transaction to the first individual's account, and wherein the account is managed by an entity;
receiving at least one criterion defined by the first individual, wherein the at least one criterion is associated with the electronic payment user interface for the first transaction;
generating an Internet accessible address to the electronic payment user interface;
receiving a request input from a second individual, different from the first individual, to access, via the Internet accessible address, the electronic payment user interface;
receiving an authorization input from the second individual to make an electronic payment of an amount of monetary funds from the second individual's account to the first individual's account; and
preventing access by the first individual to information that personally identifies the second individual,
wherein the at least one criterion comprises a maximum amount of monetary funds authorized for reception into the first individual's account.

18. The apparatus of claim 17, wherein the at least one memory storing additional computer-readable instructions that, when executed by the at least one processor, cause the apparatus to perform:
receiving a second request input from a third individual, different from the first individual and the second individual, to access, via the Internet accessible address, the electronic payment user interface;
receiving a second authorization input from the third individual to make a second electronic payment of a second amount of monetary funds from the third individual's account to the first individual's account; and
preventing access by the first individual to information that personally identifies the third individual.

19. The apparatus of claim 18, further including instructions that, when executed, cause the apparatus to:
distribute, to the second individual, a receipt indicating the amount of monetary funds transferred through the electronic payment.
